(19) United States
(12) Patent Application Publication
(10) Pub. No.: US 2004/0261961 A1
(43) Pub. Date: Dec. 30, 2004

(54) Wood treatment solution and process for improving the preservation of wood

(76) Inventors: Eero Aitta, Jokirinne (FI); Pekka Seppi, Oulu (FI)

Correspondence Address: BIRCH STEWART KOLASCH & BIRCH, PO BOX 747, FALLS CHURCH, VA, 22040-0747, US

(21) Appl. No.: 10/481,242

(22) PCT Filed: Jun. 19, 2002
(86) PCT No.: PCT/FI02/00540

(30) Foreign Application Priority Data
Jun. 19, 2001 (FI) 20011298

(51) Int. Cl. D21C 3/20; D21C 3/04; D21H 21/36; B27K 3/52

(52) U.S. Cl. 162/76; 162/161; 514/557

(57) ABSTRACT

The invention relates to a wood treatment solution which does not contain heavy metals and which contains an impregnation agent that is an alkali metal salt or alkaline-earth metal salt of formic acid or propionic acid. The invention also relates to a process for treating wood in order to improve its preservation, in which process wood is treated with the said wood treatment solution.

The invention relates to a wood treatment solution and a wood treatment process for improving the preservation of wood. The invention specifically relates to improving rot resistance of wood.

The most important biologic causes of wood deterioration are rot fungi and insects, such as termites. The preservation of wood is conventionally improved by heat treatment or pressure impregnation. In heat treatment, wood is kept at an elevated temperature (above 200° C.), which dries the wood and at the same time changes its structure. Heat treatment somewhat improves the rot resistance of wood. Excessive heat treatment weakens the mechanical properties of wood. By the heat treatment method the anti-rot results achieved are not as good as those achieved by the pressure impregnation method. In the pressure impregnation method, protection against rot is based on the impregnation of wood by means of pressure with a solution that contains, for example, a salt of copper, zinc, chromium or arsenic, or a mixture thereof, the salts preventing microbiologic activity in wood. The salts may be, for example, carboxylates, such as acetates or formates.

From patent publication WO 9527600 there is known a wood preservation agent which contains as its principal component copper acetate and possibly zinc acetate, as well as a nitrite, such as sodium nitrite, which is stated to reduce the leaching of copper and zinc ions from treated wood. In addition, this wood protection agent contains a stabilization chemical, which is an ammonium salt of a weak organic acid or a mixture of such an ammonium salt and an alkali metal salt of a weak organic acid. According to the publication, preferable stabilization agents include ammonium acetate and a mixture of ammonium acetate and sodium acetate. In this publication, also, wood protection is based on “less detrimental” metals, i.e. zinc and copper, which replace chromium and arsenic.

The use of a pressure impregnation method based on the use of heavy metals, such as Cu, Zn, Cr and As, is problematic, as is known, since such pressure-treated wood must not be burned owing to, for example, the metals present in it. Thus, pressure-treated wood is a problem waste that cannot be recycled. Heat-treated wood naturally does not present this problem, but results as good as with the pressure impregnation method (in terms of wood preservation) cannot be achieved by heat treatment.

Thus there exists a clear need for a wood treatment solution which would be as effective as the present solutions used in the pressure impregnation method but in which there would not be used chemicals rendering the wood a problem waste. It is therefore an object of the present invention to provide an environment-friendly wood treatment solution and process, and this objective is achieved through the solutions of to the invention.

According to the invention there is thus provided a wood treatment solution which does not contain heavy metals and which contains an impregnation agent that is an alkali metal salt or alkaline-earth metal salt of formic acid or propionic acid.

According to the invention there is also provided a process for the treatment of wood in order to improve its preservation, in which process wood is treated with a wood treatment solution which does not contain heavy metals and which contains an impregnation agent that is an alkali metal salt or alkaline-earth metal salt of formic acid or propionic acid.

Furthermore, according to the invention there is obtained impregnated wood which contains as an impregnation agent, in an amount of 1-20% by weight, an alkali metal salt or alkaline-earth metal salt of formic acid or propionic acid.

The said alkali metal salt or alkaline-earth metal salt of formic acid or propionic acid is preferably sodium formate, potassium formate, calcium formate or magnesium formate, and especially preferably potassium formate or calcium formate. According to the invention it is also possible to use mixtures of the said salts.

The said wood treatment solution contains preferably 2-40% by weight, more preferably 4-20% by weight, of an alkali metal salt or alkaline-earth metal salt of formic acid or propionic acid.

According to the invention the wood to be treated may be untreated wood, but preferably it is heat-treated wood. The heat treatment can suitably be carried out at a temperature of approx. 180-200° C.

The wood treatment process according to the invention can be carried out by using a procedure known per se, for example by immersing the wood to be treated in the wood treatment solution according to the invention. The treatment can be carried out under pressure, which improves the absorption of the solution into the wood.

According to the invention, an alkali metal salt or alkaline-earth metal salt of formic acid or propionic acid can be used as a wood impregnation agent for protecting wood against deterioration caused by fungi and/or insects, in particular against rot and/or termites.

By the expression “which does not contain heavy metals” is meant in this context that heavy metals are not intentionally added to the wood treatment solution. It is, however, to be understood that the solution may contain very small amounts of heavy metals derived from the water used for forming the solution. Likewise, the wood treated according to the invention may contain very small amounts of heavy metals that are naturally present in wood and/or are derived from the aqueous phase of the wood treatment solution.

The invention is based on the fact that formate, which is a chemical compound developed by ants, is a poor substrate for the growth of microorganisms. Formate has a growth-preventing effect or even an effect of killing microbiologic organisms. In general it is thought that the effect of formic acid is based on acidity, i.e. the “acid effect”. It seems, however, that specifically the formate tail is of great importance, since it has been shown that, for example, in animal feed preservation, specifically formate salts seem effectively to inhibit bacterial activity. Propionic acid and salts of propionic acid are also used in animal feed preservation to improve the preservation of feed, and thus it is natural to assume that the alkali salts or alkaline-earth metal salts of propionic acid have a wood-preserving effect similar to that of formic acid and its salts.

The invention is described below in greater detail with the help of examples, examining anti-rot treatment of on the one hand ordinary and on the other hand heat-treated pine and spruce with the wood treatment solution according to the invention. By heat treatment is meant a conventional procedure wherein wood is kept at an elevated temperature, whereby moisture is removed from the wood and the structure of the wood is changed.

### EXAMPLES

Preliminary Tests

A board specimen was kept for several days in a strong potassium formate solution. After impregnation, the board was in summer buried in a garden plot together with untreated board taken from the same board specimen. The following summer the boards were dug up, whereupon it was observed that the treated board had remained without any decay. Instead, on the untreated board, decay had started, it smelled of mold and was water-soaked and blackened.

Next, a test was performed in which a piece of wood was impregnated with potassium formate. This and an untreated wood specimen were placed in a closed and humid space containing rot fungi. After the test period, it was observed that there had not occurred decay in either sample. This was due to the fact that the potassium formate had dissolved in water and had at the same time inhibited all decay activity in the experimental space. It was decides that in the following phase Ca formate poorly soluble in water would be tested.

Impregnation of Blocks of Wood with a Ca Formate Solution

The tests were carried out by using test specimens made from spruce or pine wood. The size of specimens made of pine was approx. 20×15×2.4 cm³ and respectively the size of the specimens made from spruce was approx. 20×12×7.2 cm³. One half of the wood specimens were subjected to a heat treatment at 190° C. This heat treatment did not notably affect the rot resistance of the wood but it improved the absorption of the solution, since heat-treated wood is more porous than untreated wood. One half of the specimens were subjected to no heat treatment. The wood specimens were measured and weighed before the chemical treatment. Neither chemical nor heat treatment was carried out on the reference specimens that were used in the accelerated rotting tests described below.

The chemical treatment was carried out by immersion of the wood specimens in a closed vessel containing Ca formate solution (concentrations 120 g/kg, 80 g/kg and 40 g/kg). The temperature of the solution was 40-50° C. In the vessel there prevailed a pressure of approx. 150 kPa (1.5 bar), by means of which the solution was “forced” into the wood. The treatment time was 2 h. After the chemical treatment the wood specimens were dried in an incubator overnight at 80-90° C.

The results of the impregnation test are shown in Table 1.

TABLE 1
Absorption of Ca formate solution into pine and spruce. The absorption
is indicated in units of mg of Ca formate/cm³ of wood.

| Solution | Pine | | Spruce | |
|---|---|---|---|---|
| g/kg | Ordinary | Heat-treated | Ordinary | Heat-treated |
| Ca formate 120 | 25 | 60 | 7 | 32 |
| Ca formate 80 | 3 | 38 | 5 | 17 |
| Ca formate 40 | —*⁾ | 26 | —*⁾ | 17 |

*)after the drying step the sample was lighter than before treatment with the solution

It can be seen from the results of the impregnation tests that formate solution is absorbed considerably better into heat-treated wood, which is more porous than ordinary wood. Furthermore, the solution is better absorbed into pine. The density of heat-treated wood is approx. 400 mg/cm³. Thus the amount of Ca formate in heat-treated wood is approx. 7-15% for pine and 4-8% for spruce.

Accelerated Rotting Tests

In the next phase the specimens treated above were sent to a rot fungus test. European standard EN 113 was applied in carrying out the test. The wood was exposed to conditions as rigorous as possible with respect to decay: temperature was approx. 30° C. and humidity 100%, and bad rot fungi such as Poria placenta, Gloeophyllum trabeum and Coniophora puteana had been introduced into the testing space (culture flask). These fungi are present in all rotting objects. The test lasted for 4 months. A reference specimen that had not been heat-treated was included in each test. The rotting of such wood should in an accelerated rotting test be such that the weight loss is at least 20% with each fungus species. The specimens were weighed before the beginning of the test.

The results of the accelerated rotting tests for spruce are shown in Tables 2-4 and for pine in Tables 5-7. In the examination of the results it is advisable to use as a reference value the known information according to which a weight loss of 20-30% is reached with heat-treated spruce and pine in these test conditions.

TABLE 2
Decay of spruce specimens when the rot fungus was
Gloeophyllum trabeum. The heat-treated wood was
treated with Ca formate having a concentration of 80 g/kg.

| | | Weight loss %, |
|---|---|---|
| | Weight loss %, | untreated reference |
| Repeat test | treated wood | specimen |
| 1 | 3.73 | 44.21 |
| 2 | 4.45 | 38.70 |
| 3 | 6.55 | 35.51 |
| 4 | 3.71 | 42.18 |
| Mean | 4.61 | 40.15 |

TABLE 3
Decay of spruce specimens when the rot fungus was
Coniophora puteana. The heat-treated wood was
treated with Ca formate having a concentration of 80 g/kg.

| | | Weight loss %, |
|---|---|---|
| | Weight loss %, | untreated reference |
| Repeat test | treated wood | specimen |
| 1 | 0.11 | 58.34 |
| 2 | 0.10 | 55.35 |
| 3 | 0.23 | 50.22 |
| 4 | 0.89 | 52.34 |
| Mean | 0.33 | 54.06 |

TABLE 4
Decay of spruce specimens when the rot fungus was
Poria placenta. The heat-treated wood was treated
with Ca formate having a concentration of 80 g/kg.

| | | Weight loss %, |
|---|---|---|
| | Weight loss %, | untreated reference |
| Repeat test | treated wood | specimen |
| 1 | 15.62 | 36.21 |
| 2 | 13.94 | 26.31 |
| 3 | 0.14 | 37.58 |
| 4 | 14.71 | 28.20 |
| Mean | 11.10 | 32.07 |

TABLE 5
Decay of pine specimens when the rot fungus was
Gloephyllum trabeum. The heat-treated wood was
treated with Ca formate having a concentration of 80 g/kg.

| | | Weight loss %, |
|---|---|---|
| | Weight loss %, | untreated reference |
| Repeat test | treated wood | specimen |
| 1 | 1.12 | 14.81 |
| 2 | 0.13 | 34.46 |
| 3 | 0.38 | 46.89 |
| 4 | 0.75 | 33.67 |
| Mean | 0.59 | 32.46 |

TABLE 6
Decay of pine specimens when the rot fungus was
Coniophora puteana. The heat-treated wood was
treated with Ca formate having a concentration of 80 g/kg.

| | | Weight loss %, |
|---|---|---|
| | Weight loss %, | untreated reference |
| Repeat test | treated wood | specimen |
| 1 | 0.84 | 44.10 |
| 2 | 0.17 | 47.43 |
| 3 | 0.01 | 46.93 |
| 4 | 0.27 | 38.47 |
| Mean | 0.32 | 44.23 |

TABLE 7
Decay of pine specimens when the rot fungus was
Poria placenta. The heat-treated wood was
treated with Ca formate having a concentration of 80 g/kg.

| | | Weight loss %, |
|---|---|---|
| | Weight loss %, | untreated reference |
| Repeat test | treated wood | specimen |
| 1 | 13.72 | 23.87 |
| 2 | 6.95 | 24.37 |
| 3 | 6.23 | 30.83 |
| 4 | 8.79 | 24.46 |
| Mean | 8.93 | 25.88 |

The results show that decay was rapid in the reference specimens. After four months, up to one-half of the untreated wood had rotted, i.e. burned (e.g. Table 3). For pine, the means ranged from 26 to 44%; for spruce from 32 to 54%. For specimens treated according to the invention the respective ranges were 0.3-9% for pine and 0.3-11% for spruce. Poria placenta was the worst cause of rot.

Table 8 shows the results by using the classification according to standard EN 350-1994. The standard uses rot resistance classification 1-5, of which class 1=well resistant to rot, class 2=rot resistant, class 3=moderately rot resistant, class 4=poorly resistant, and class 5=not resistant.

TABLE 8
Rot resistance of wood treated according to the invention
with respect to three different rot fungi

| Fungus | Treated spruce | Treated pine |
|---|---|---|
| Poria placenta | Class 3 | Class 3 |
| Coniophora puteana | Class 1 | Class 1 |
| Gloeophyllum trabeum | Class 1 | Class 1 |

On the basis of these rotting tests it can be noted that rot resistance increased considerably as compared with untreated wood. A considerable improvement is produced by heat treatment. If a treatment with Ca formate according to the invention is carried out in addition to heat treatment, rotting can be prevented almost completely.

For both spruce and pine, the worst agent causing decay was Poria placenta. As to the other fungi, heat treatment caused a considerable decrease in decay, but the chemical treatment in practice stopped the decay. Overall, the results are good.

The solution according to the invention does not contain any toxic components. The wood is completely recyclable and can be burned freely. The amount of wood treatment agent is approx. 10% of the amount of wood, and thus the invention is also economical.

In addition to anti-rot treatment, the process can also be used for preventing destruction caused by termites. Termites destroy a considerable amount of timber in southern hot conditions. By treating heat-treated timber with the solution according to the invention, effective protection is thus obtained against termites.

1. A wood treatment solution which does not contain heavy metals and which contains an impregnation agent that is an alkali metal salt or alkaline-earth metal salt of formic acid or propionic acid.

2. The wood treatment solution according to claim 1, characterized in that it contains as an impregnation agent sodium formate, potassium formate, calcium formate or magnesium formate, preferably potassium formate or calcium formate.

3. The wood treatment solution according to claim 1 or 2, characterized in that it contains the alkali metal salt or alkaline-earth metal salt of formic acid or propionic acid in an amount of 2-40% by weight, preferably 4-20% by weight.

4. A process for treating wood in order to improve its preservation, characterized in that wood is treated with a wood treatment solution which does not contain heavy metals and which contains an impregnation agent that is an alkali metal salt or alkaline-earth metal salt of formic acid or propionic acid.

5. The process according to claim 4, characterized in that the wood treatment solution contains as the impregnation agent sodium formate, potassium formate, calcium formate or magnesium formate, preferably potassium formate or calcium formate.

6. The process according to claim 4 or 5, characterized in that the wood treatment solution contains the alkali metal salt or alkaline-earth metal salt of formic acid or propionic acid in an amount of 2-40% by weight, preferably 4-20% by weight.

7. The process according to claim 4, characterized in that the wood being treated is heat-treated wood.

8. Impregnated wood which contains as an impregnation agent an alkali metal salt or alkaline-earth metal salt of formic acid or propionic acid in an amount of 1-20% by weight.

9. The wood according to claim 8, characterized in that it contains as the impregnation agent sodium formate, potassium formate, calcium formate or magnesium formate, preferably potassium formate or calcium formate.

10. The wood according to claim 8 or 9, characterized in that the wood is heat-treated wood.

11. Use of an alkali metal salt or alkaline-earth metal salt of formic acid or propionic acid as an impregnation agent to protect wood against deterioration caused by fungi and/or insects.

12. The use according to claim 11, characterized in that the said salt is used for protecting wood against rot and/or termites.
